(19) United States
(12) Patent Application Publication
(10) Pub. No.: US 2010/0142140 A1
(43) Pub. Date: Jun. 10, 2010

(54) APPARATUS FOR AND SYSTEM AND METHOD OF DELIVERING DIGITAL CONTENT

(76) Inventor: Adil Atawulla, Walnut Creek, CA (US)

Correspondence Address: WEST & ASSOCIATES, A PC, 1255 Treat Blvd., 3rd Floor, WALNUT CREEK, CA, 94597, US

(21) Appl. No.: 12/478,729

(22) Filed: Jun. 4, 2009

Related U.S. Application Data
(60) Provisional application No. 61/058,863, filed on Jun. 4, 2008.

(51) Int. Cl. G06F 1/16

(52) U.S. Cl. 361/679.31

(57) ABSTRACT

An apparatus, system and method for delivering digital content wherein a digital content device can be selectively programmed with digital content specific to a user's request and on-demand.

### BACKGROUND

1. Field of the Invention

The present disclosure relates generally to the field of digital content delivery and storage products and more specifically to a system, method and associated apparatus for obtaining, delivering and transporting digital contents.

2. Background

In the modern digital age, sending mail by traditional means such as through the United States Postal Service is becoming less desirable. Paper postcards, letters, and advertisements are increasingly seen as a hassle and waste of precious environmental resources. However, for many businesses a combination of modern electronic information and postal mail is still an effective marketing tool. Digital content drives are small non-volatile electronic devices with a predetermined amount of memory, similar to a computer's hard drive. They can come in various profiles and geometries ranging from USB and 1394 devices to SD and Compact Digital content devices, to name just a few. These digital content drives can be pre-loaded with a business's marketing information and sent to consumers as a way to attract business. This type of marketing is becoming increasingly popular and effective, not only for it's use of modern technology instead of traditional paper advertisements, but also because it evokes interest and curiosity in the minds of consumers.

Even when padded, traditional mailing envelopes do not ensure that a digital content drive will arrive at its destination in pristine condition. Small boxes may be used, however they are generally too large for a digital content drive, which can get tossed around inside the box during transit if unaccompanied by sufficient padding material. Therefore, it is desirable to have a mailing device with a hollow portion that can accommodate a digital content drive and provide a snug fit for secure transport of the digital content drive. It is also preferable to have a mailing device with a substantially planar portion for handwriting addresses or other information or affixing labels. Further, it is desirable to have a mailing device which is equipped with a female port for receiving and securely fitting to the male end of a digital content drive.

Additionally in this age of digital technology and high-speed computing and internet access, it is archaic to require retail “brick and mortar” stores to purchase physical instances of digital content, when such content could be readily stored as a single copy and duplicated at a high-speed only when needed. With the advent of portable digital devices, the antiquated system of requiring a retail establishment to purchase multiple copies of digital content and store the physical instances until a consumer is ready to purchase the item is not only a waste of physical space within a store, but also a waste of operating capital for the retail establishment.

What is needed is a device with a hollow portion that can accommodate a digital content drive and provide a snug fit for secure transport of the digital content drive and a system, method and apparatus for rapidly creating physical instances of digital content, upon demand, whereby a retail establishment does not pay for the physical instance until such time as a consumer has purchased or is purchasing a copy of the digital content.

### BRIEF DESCRIPTION OF THE DRAWINGS

FIGS. 1A-1C depict views of an embodiment of the present device.

FIG. 1A depicts a perspective view of an embodiment of the present device with a digital content drive being inserted therein.

FIG. 1B depicts a perspective view of an embodiment of the present device which shows an interior female port.

FIG. 1C depicts various embodiments of apparatuses in which the a digital storage device can be implemented.

FIG. 2 depicts an embodiment of a magazine delivery system and apparatus.

FIG. 3 depicts an embodiment of a video delivery system and apparatus.

FIG. 4 depicts an embodiment of a book (audio or text) delivery system and apparatus.

FIG. 5 depicts an embodiment of a software delivery system and apparatus.

FIG. 6 depicts an embodiment of an ID/Nametag system and apparatus.

FIG. 7 depicts an embodiment of an e-card delivery system and apparatus.

FIG. 8 depicts an embodiment of a brochure delivery system and apparatus.

FIG. 9 depicts an embodiment of a catalog delivery system and apparatus.

FIG. 10 depicts an embodiment of an advertisement delivery system and apparatus.

FIGS. 11A and B depict embodiments of a package file delivery system and apparatus.

FIG. 12 depicts an embodiment of a system of implementing digital content delivery.

FIG. 13 depicts an embodiment of a method of implementing digital content delivery.

FIG. 14 depicts a network system over which the system and method could be operated.

### DETAILED DESCRIPTION

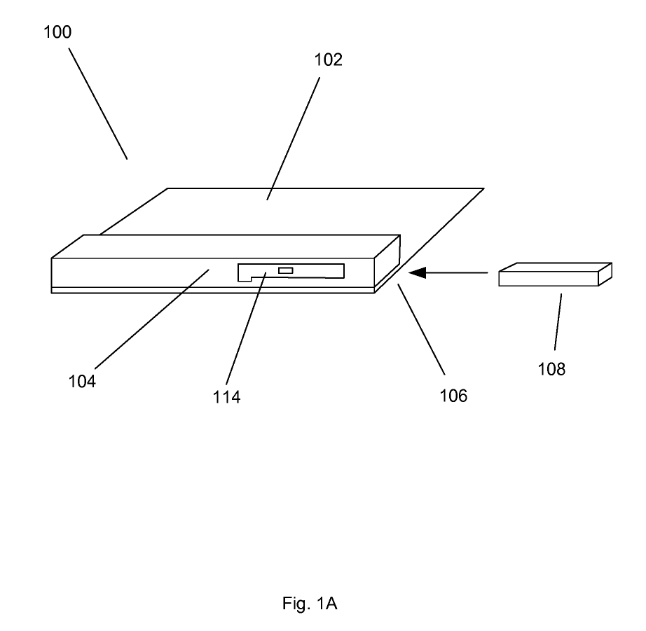

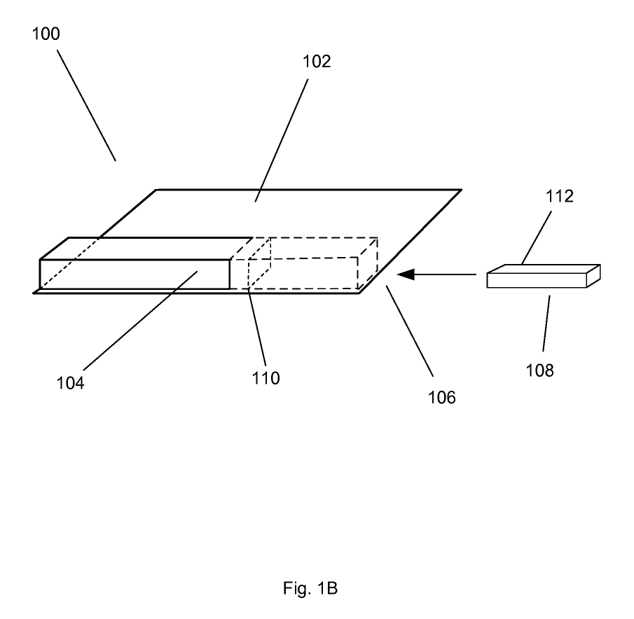

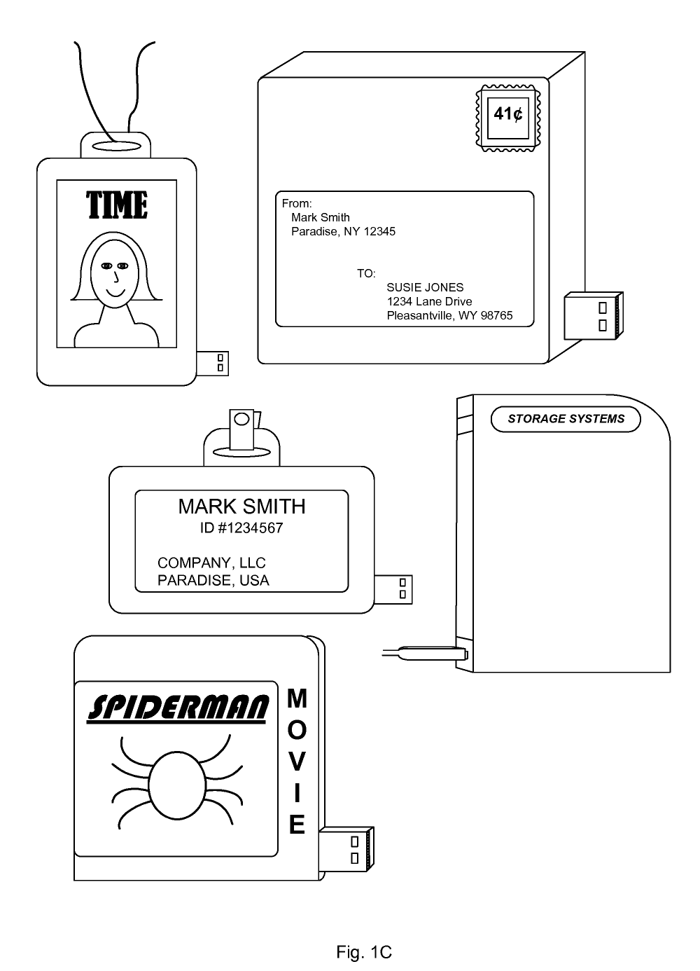

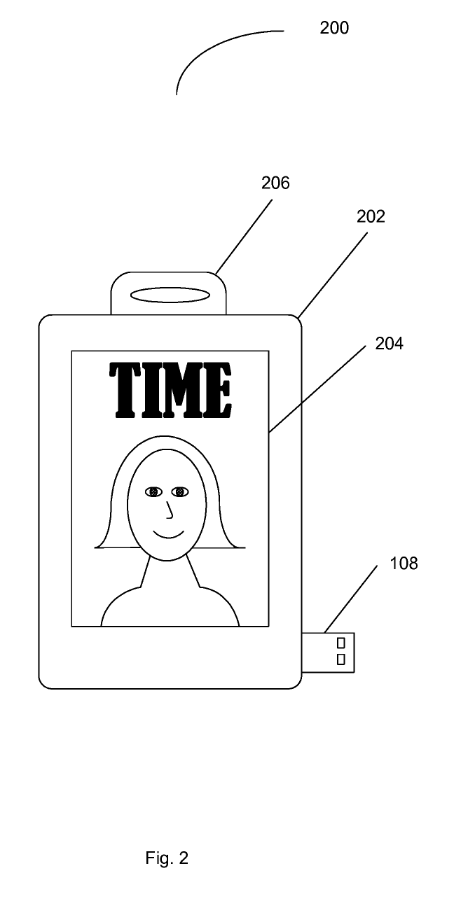

FIGS. 1A and 1B depict perspective views of an embodiment of the present device. A substantially planar member 102 can have a first surface and a second surface, said first surface having a protrusion 104 attached thereto. Protrusion 104 can have an opening 106 for selectively receiving and securing a digital content drive 108, as shown in FIG. 1A. In some embodiments the digital content drive 108 can be fully removable. However, in alternate embodiments the digital content drive 108 can be only partially removable from the protrusion 104. In some embodiments the digital content drive 108 can frictionally engage the interior walls of the protrusion. However, in alternate embodiments any know and/or convenient mechanism can be employed to selectively engage the digital content drive 108 within the protrusion 104. As shown in FIG. 1B, a protrusion 104 can have an interior female port 110 that can receive the male end 112 of a digital content drive 108 and/or any other desired USB or desired device.

The substantially planar member 102 can be plastic, paper, cardboard, metal or any other known and/or convenient material for shipping through postal mail. The protrusion 104 can also be plastic, paper, cardboard, metal or any other known and/or convenient material. The exterior of a digital content drive 108 can be plastic, polymer or any other known/and or convenient material. In some embodiment the substantially planar member 102 can have any known and/or desired designs which can be indicative of use and/or can portray any desired image and/or contain any desired text. In still further alternate embodiment the substantially planar member can include an addressable region, a postage region and an identifier region. In some embodiments the addressable region can be comprised of a surface that can be easily marked using any known and/or convenient writing implement. In some embodiments the postage region can be comprised of a surface to which conventional postage can be adhered. In some embodiments the identifier region can include a bar code, stock keeping unit (SKU) number, pictures, logos, ISBN and/or any other desired information.

In an alternate embodiment, the substantially planar member 102 can have a thickness at least a great as that of a digital content drive 108. However in alternate embodiments, the planer member 102 can be thinner than and/or the same thickness as the digital content drive 108. In some embodiments, the substantially planar member 102 can have an opening 106 on at least one side for receiving and securing a digital content drive 108.

In use, a digital content drive 108 can be inserted into the opening 106 of a protrusion 104 of the present device 100. The male end 112 of the digital content drive 108 can be secured to an interior female port 110 of the protrusion 104. In alternate embodiments the roles of male and female ports can be reversed and/or any alternate mating mechanism can be employed. When a digital content drive 108 is completely secured inside the present device 100, the present device 100 can be sent through postal mail for secure transport of a digital content drive 108. Additionally, a user can write on or affix a label to the first and/or second surface of the substantially planar member 102. In some embodiments the digital content drive 108 can be pre-loaded with any desired data and/or program and/or can be sold with loadable software and/or sold containing a software key which can be used to activate software downloaded and/or otherwise obtained elsewhere.

In some embodiments the protrusion 104 can have an opening 114 that can allow a portion of the digital content drive 108 to extend through a section of the protrusion 104 other than the section where the male and/or female ends of the digital content drive 108 are accessible. In some embodiments the opening 114 can allow a mechanically operated mechanism to be operated such that the engageable portion of the digital content drive 108 can be selectively extended from the protrusion 104.

FIG. 1C depicts a group of alternate embodiments of the present device, including a magazine delivery system, a package mailing system, a name/ID tag system, a software delivery system and a movie delivery system. In alternate embodiments, the digital content delivery device can be included in any known and/or convenient packaging and/or delivery system.

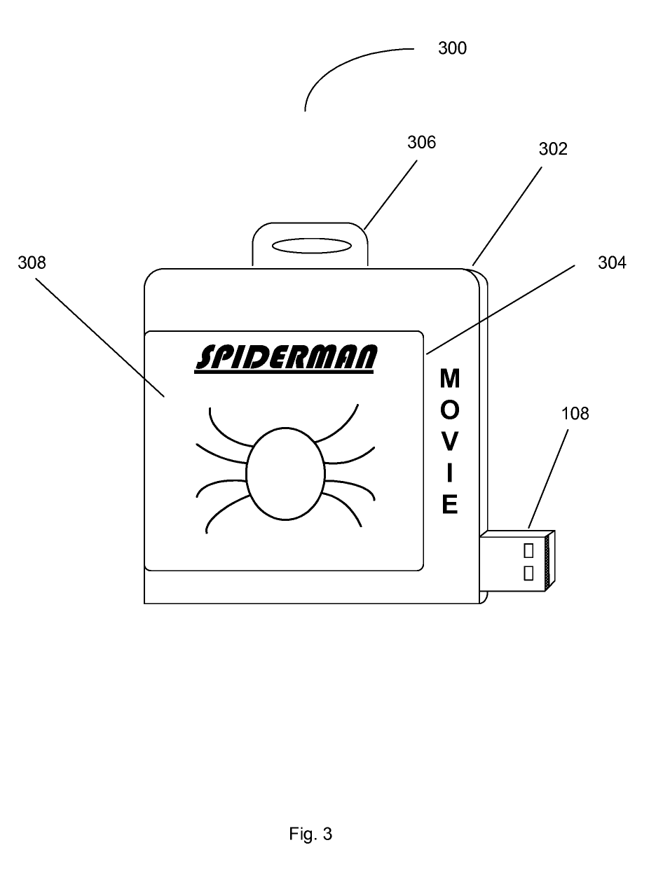

FIG. 2 depicts an embodiment of a magazine delivery system 200. In the embodiment depicted in FIG. 2, the delivery system 200 can be comprised of a package 202 that can include a graphic/text region 204, a display connection element 206 and a digital content drive 108.

In some embodiments the graphic/text region 204 can be a display that can be associated with the digital content stored on the drive 108. Moreover, in some embodiment, the graphic/text region 204 can access portions of the data stored on the drive 108 and display static and/or changing text and graphics depending on the contents of the drive 108. In alternate embodiments, the graphic/text region 204 can be static graphics and/or text based that merely identifies the general content of the drive 108. In still further alternate embodiments, the contents of the graphic/text region 204 can be controlled by an independent source and/or can be blank. In still further alternate embodiments, the graphics/text region 204 can be merely a region adapted to selectively receive an adhesive sticker containing identifying information that may be selectively and/or permanently adhered to the package 202. In still further alternate embodiments, the region 204 may not be present.

In the embodiment depicted in FIG. 2, the device includes a display connection element 206. In the embodiment depicted in FIG. 2, the display connection element 206 is shown as an affixed element having a penetration such that the package 202 can be hung and/or displayed on a hanging form. However, in alternate embodiments the display connection element 206 can be permanently and/or removably coupled with the package 202 in any known and/or convenient manner and in any known and/or convenient location on the package 202. In still further alternate embodiments, the display connection element 206 may be absent.

In the embodiment depicted in FIG. 2, the digital content drive 108 can be coupled with the package in any known and/or convenient manner and have any desired features as described in with reference to FIGS. 1-1C. In some embodiments, the drive 108 can be coupled with the package in any one or more of the manner described above in relation to FIGS. 1-1C.

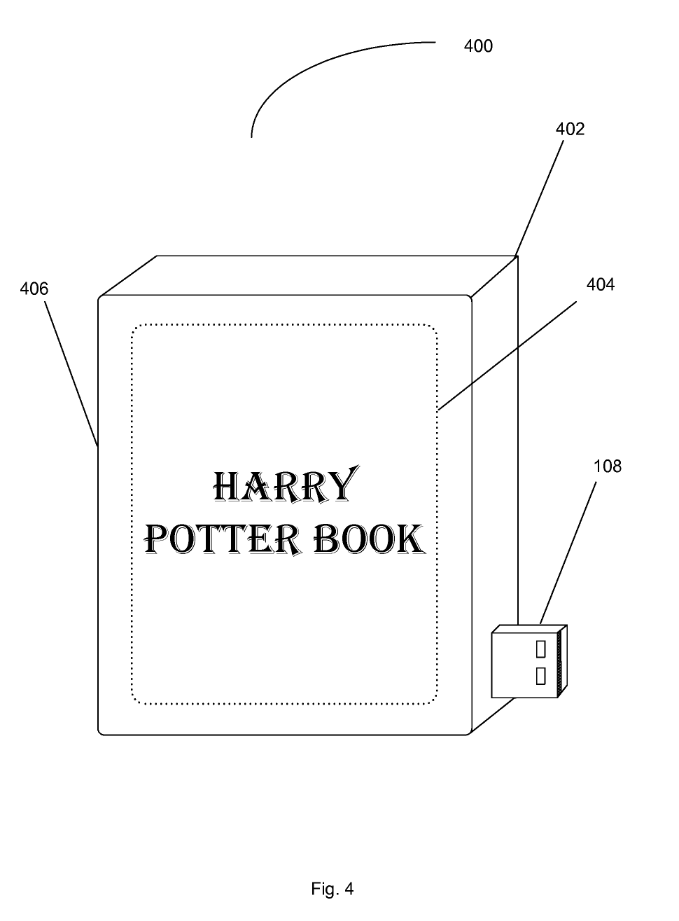

FIG. 3 depicts an embodiment of a video delivery system 300. In the embodiment depicted in FIG. 3, the delivery system 300 can be comprised of a package 302 that can include a graphic/text region 304, a display connection element 306 and a digital content drive 108.

In some embodiments the graphic/text region 304 can be a display that can be associated with the digital content stored on the drive 108. Moreover, in some embodiment, the graphic/text region 304 can access portions of the data stored on the drive 108 and display static and/or changing text and graphics depending on the contents of the drive 108. In alternate embodiments, the graphic/text region 304 can be static graphics and/or text based that merely identifies the general content of the drive 108. In still further alternate embodiments, the contents of the graphic/text region 304 can be controlled by an independent source and/or can be blank. In still further alternate embodiments, the graphics/text region 304 can be merely a region adapted to selectively receive an adhesive sticker containing identifying information that may be selectively and/or permanently adhered to the package 302. In still further alternate embodiments, the region 304 may not be present. In some embodiments, the graphic/text region 304 can include a transparent and/or semi-transparent sleeve 308 which would allow a user to selectively insert a card containing any desired graphic, image and/or text.

In the embodiment depicted in FIG. 3, the device includes a display connection element 306. In the embodiment depicted in FIG. 3, the display connection element 306 is shown as an affixed element having a penetration such that the package 302 can be hung and/or displayed on a hanging form. However, in alternate embodiments the display connection element 306 can be permanently and/or removably coupled with the package 302 in any known and/or convenient manner and in any known and/or convenient location on the package 302. In still further alternate embodiments, the display connection element 306 may be absent.

In the embodiment depicted in FIG. 3, the digital content drive 108 can be coupled with the package in any known and/or convenient manner and have any desired features as described in with reference to FIGS. 1-1C. In some embodiments, the drive 108 can be coupled with the package in any one or more of the manner described above in relation to FIGS. 1-1C.

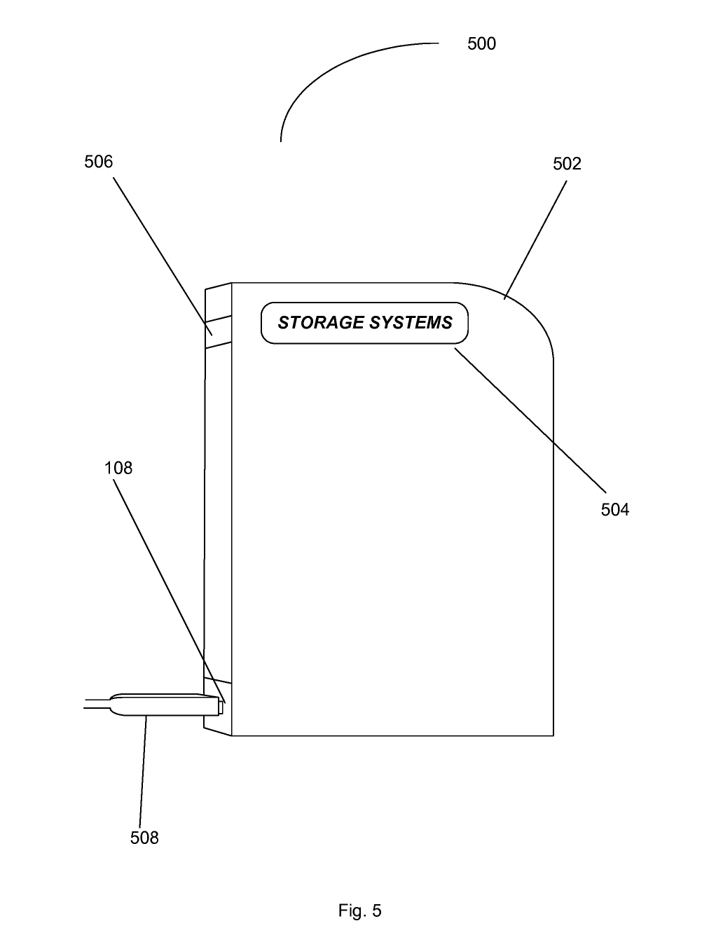

FIG. 4 depicts an embodiment of an audio and/or textural book delivery system 400. In the embodiment depicted in FIG. 4, the delivery system 400 can be comprised of a package 402 that can include a graphic/text region 404, a spine display element 406 and a digital content drive 108.

In some embodiments the graphic/text region 404 can be a display that can be associated with the digital content stored on the drive 108. Moreover, in some embodiment, the graphic/text region 404 can access portions of the data stored on the drive 108 and display static and/or changing text and graphics depending on the contents of the drive 108. In alternate embodiments, the graphic/text region 404 can be static graphics and/or text based that merely identifies the general content of the drive 108. In still further alternate embodiments, the contents of the graphic/text region 404 can be controlled by an independent source and/or can be blank. In still further alternate embodiments, the graphics/text region 404 can be merely a region adapted to selectively receive an adhesive sticker containing identifying information that may be selectively and/or permanently adhered to the package 402. In still further alternate embodiments, the region 404 may not be present.

In the embodiment depicted in FIG. 4, the device includes a spine display element 406. In the embodiment depicted in FIG. 4, the spine display element 406 can be an affixed graphic/text region as described above, located on a separate face of the package 402. In some embodiments, the spine display element 406 may be absent. In some embodiments the spine display element 406 can be coupled with the package 402 such that in a first position the spine display element 506 covers the connection port of the drive 108 when the drive 108 is in a retracted state and in a second position, the spine display element 406 leaves the connection port of the drive 108 exposed.

In the embodiment depicted in FIG. 4, the digital content drive 108 can be coupled with the package in any known and/or convenient manner and have any desired features as described in with reference to FIGS. 1-1C. In some embodiments, the drive 108 can be coupled with the package in any one or more of the manner described above in relation to FIGS. 1-1C.

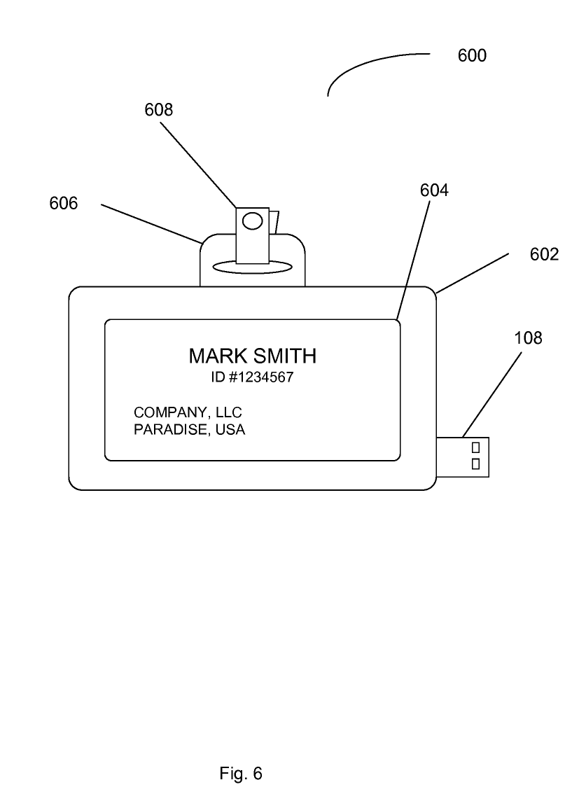

FIG. 5 depicts an embodiment of a software delivery system 500. In the embodiment depicted in FIG. 5, the delivery system 500 can be comprised of a package 502 that can include a graphic/text region 504, a spine display element 506 and a digital content drive 108.

In some embodiments the graphic/text region 504 can be a display that can be associated with the digital content stored on the drive 108. Moreover, in some embodiment, the graphic/text region 504 can access portions of the data stored on the drive 108 and display static and/or changing text and graphics depending on the contents of the drive 108. In alternate embodiments, the graphic/text region 504 can be static graphics and/or text based that merely identifies the general content of the drive 108. In still further alternate embodiments, the contents of the graphic/text region 504 can be controlled by an independent source and/or can be blank. In still further alternate embodiments, the graphics/text region 504 can be merely a region adapted to selectively receive an adhesive sticker containing identifying information that may be selectively and/or permanently adhered to the package 502. In still further alternate embodiments, the region 504 may not be present.

In the embodiment depicted in FIG. 5, the device includes a spine display element 506. In the embodiment depicted in FIG. 5, the spine display element 506 can be an affixed graphic/text region as described above, located on a separate face of the package 502. In some embodiments, the spine display element 506 may be absent. In some embodiments the spine display element 506 can be coupled with the package 502 such that in a first position the spine display element 506 covers the connection port of the drive 108 when the drive 108 is in a retracted state and in a second position, the spine display element 506 leaves the connection port of the drive 108 exposed. Additionally in some embodiments, the package 502 can be opened and additional content can be added to the package 502.

In the embodiment depicted in FIG. 5, the digital content drive 108 can be coupled with the package in any known and/or convenient manner and have any desired features as described in with reference to FIGS. 1-1C. In some embodiments, the drive 108 can be coupled with the package in any one or more of the manner described above in relation to FIGS. 1-1C.

In the embodiment depicted in FIG. 5, the drive 108 associated with the package 108 is depicted as being associated with a tether 508. In some embodiments, the tether can be coupled with a device capable of either activating and/or introducing digital content on/to the drive 108.

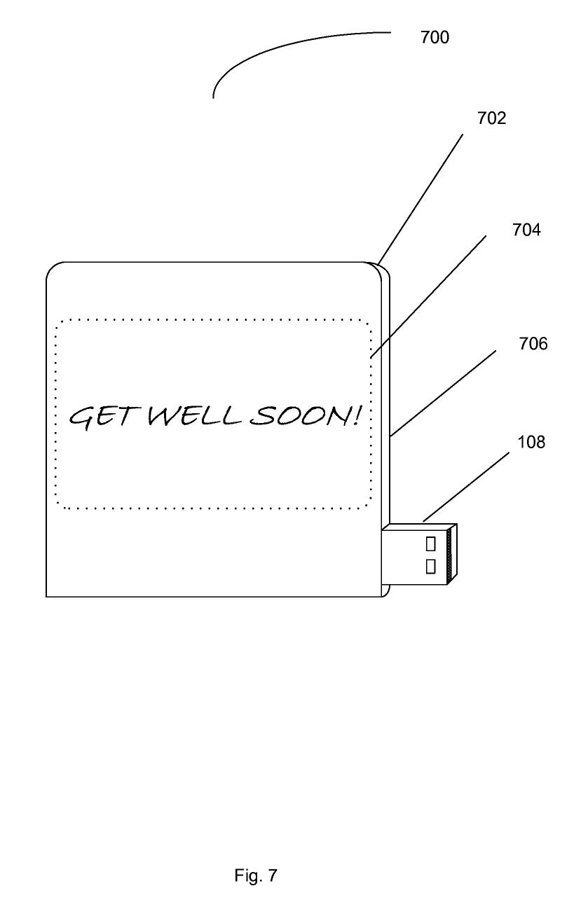

FIG. 6 depicts an embodiment of a nametag/ID system 600. In the embodiment depicted in FIG. 6, the system 600 can be comprised of a package 602 that can include a graphic/text region 604, one or more connection elements 606 608 and a digital content drive 108.

In some embodiments the graphic/text region 604 can be a display that can be associated with the digital content stored on the drive 108. Moreover, in some embodiment, the graphic/text region 604 can access portions of the data stored on the drive 108 and display static and/or changing text and graphics depending on the contents of the drive 108. In alternate embodiments, the graphic/text region 604 can be static graphics and/or text based that merely identifies the general content of the drive 108. In still further alternate embodiments, the contents of the graphic/text region 604 can be controlled by an independent source and/or can be blank. In still further alternate embodiments, the graphics/text region 604 can be merely a region adapted to selectively receive an adhesive sticker containing identifying information that may be selectively and/or permanently adhered to the package 602. In still further alternate embodiments, the region 604 may not be present.

In the embodiment depicted in FIG. 6, the device includes connection elements 606 608. In the embodiment depicted in FIG. 6, one connection element 606 is shown as an affixed element having a penetration such that the package 602 can be hung and/or displayed on a hanging element. Additionally, hanging element 608 is depicted as being selectively couplable with connection element 606. However, in alternate embodiments one or both of the display connection elements 606 608 can be permanently and/or removably coupled with the package 602 in any known and/or convenient manner and in any known and/or convenient location on the package 602. In still further alternate embodiments, the display one or more of the connection elements 606 608 may be absent.

In the embodiment depicted in FIG. 6, the digital content drive 108 can be coupled with the package in any known and/or convenient manner and have any desired features as described in with reference to FIGS. 1-1C. In some embodiments, the drive 108 can be coupled with the package in any one or more of the manner described above in relation to FIGS. 1-1C.

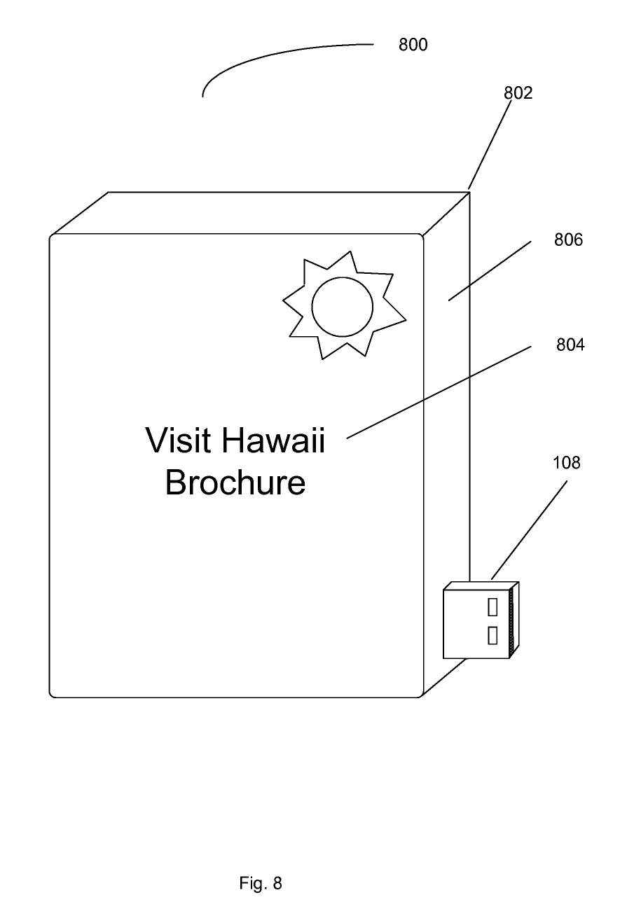

FIG. 7 depicts an embodiment of a card delivery system 700. In the embodiment depicted in FIG. 7, the delivery system 700 can be comprised of a package 702 that can include a graphic/text region 704, an internal message section 706 and a digital content drive 108.

In some embodiments the graphic/text region 704 can be a display that can be associated with the digital content stored on the drive 108. Moreover, in some embodiment, the graphic/text region 704 can access portions of the data stored on the drive 108 and display static and/or changing text and graphics depending on the contents of the drive 108. In alternate embodiments, the graphic/text region 704 can be static graphics and/or text based that merely identifies the general content of the drive 108. In still further alternate embodiments, the contents of the graphic/text region 704 can be controlled by an independent source and/or can be blank. In still further alternate embodiments, the graphics/text region 704 can be merely a region adapted to selectively receive an adhesive sticker containing identifying information that may be selectively and/or permanently adhered to the package 702. In still further alternate embodiments, the region 704 may not be present.

In the embodiment depicted in FIG. 7, the device includes an internal message section 706. In the embodiment depicted in FIG. 7, the internal message section 706 can be, as in a standard card, a writable area located between a front and back, foldable cover. That is, the package itself can be folded like a card to have a front and back and two interior surfaces. However, in alternate embodiments the internal message section 706 can be permanently and/or removably coupled with the interior and/or exterior of the package 702 in any known and/or convenient manner and in any known and/or convenient location on the package 702. In still further alternate embodiments, the internal message section 706 may be absent.

In the embodiment depicted in FIG. 7, the digital content drive 108 can be coupled with the package in any known and/or convenient manner and have any desired features as described in with reference to FIGS. 1-1C. In some embodiments, the drive 108 can be coupled with the package in any one or more of the manner described above in relation to FIGS. 1-1C.

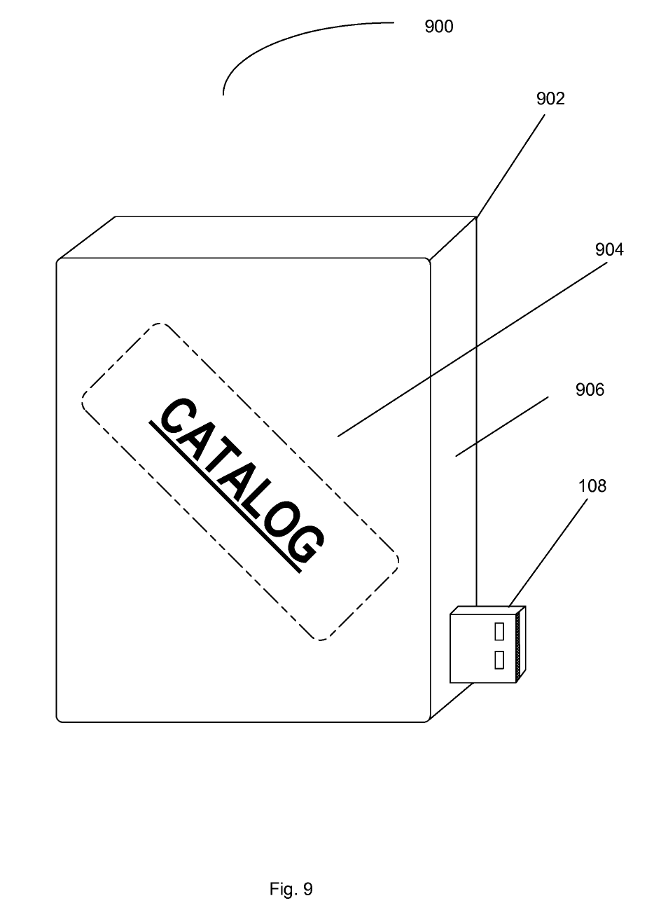

FIG. 8 depicts an embodiment of a brochure delivery system 800. In the embodiment depicted in FIG. 8, the delivery system 800 can be comprised of a package 802 that can include a graphic/text region 804, an internal message section 806 and a digital content drive 108.

In some embodiments the graphic/text region 804 can be a display that can be associated with the digital content stored on the drive 108. Moreover, in some embodiment, the graphic/text region 804 can access portions of the data stored on the drive 108 and display static and/or changing text and graphics depending on the contents of the drive 108. In alternate embodiments, the graphic/text region 804 can be static graphics and/or text based that merely identifies the general content of the drive 108. In still further alternate embodiments, the contents of the graphic/text region 804 can be controlled by an independent source and/or can be blank. In still further alternate embodiments, the graphics/text region 804 can be merely a region adapted to selectively receive an adhesive sticker containing identifying information that may be selectively and/or permanently adhered to the package 802. In still further alternate embodiments, the region 804 may not be present.

In the embodiment depicted in FIG. 8, the device includes an internal message section 806. In the embodiment depicted in FIG. 8, the internal message section 806 can be, as in a standard brochure, written content located between a front and back, foldable cover. That is, the package itself can be folded in any known and/or convenient manner to have a front and back and any number of interior surfaces. However, in alternate embodiments the internal message section 806 can be permanently and/or removably coupled with the interior and/or exterior of the package 802 in any known and/or convenient manner and in any known and/or convenient location on the package 802. In still further alternate embodiments, the internal message section 806 may be absent.

In the embodiment depicted in FIG. 8, the digital content drive 108 can be coupled with the package in any known and/or convenient manner and have any desired features as described in with reference to FIGS. 1-1C. In some embodiments, the drive 108 can be coupled with the package in any one or more of the manner described above in relation to FIGS. 1-1C.

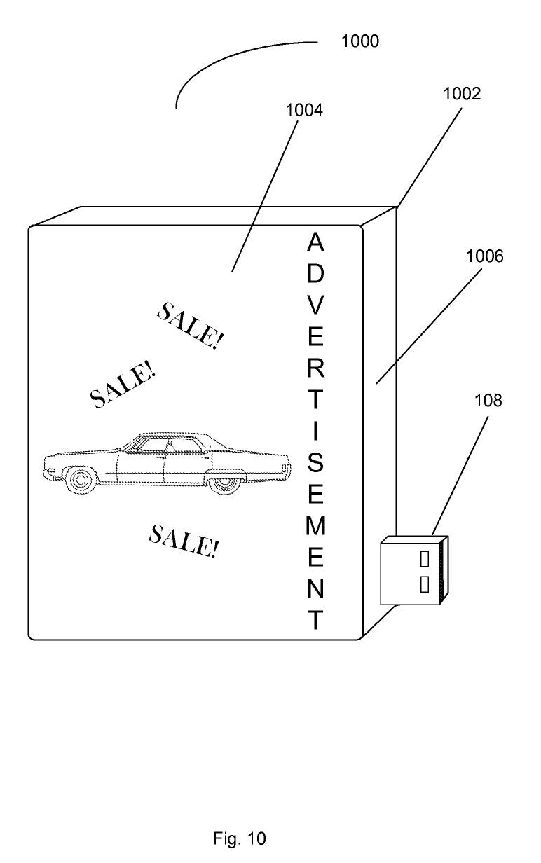

FIG. 9 depicts an embodiment of a catalog delivery system 900. In the embodiment depicted in FIG. 9, the delivery system 900 can be comprised of a package 902 that can include a graphic/text region 904, an internal message section 906 and a digital content drive 108.

In some embodiments the graphic/text region 904 can be a display that can be associated with the digital content stored on the drive 108. Moreover, in some embodiment, the graphic/text region 904 can access portions of the data stored on the drive 108 and display static and/or changing text and graphics depending on the contents of the drive 108. In alternate embodiments, the graphic/text region 904 can be static graphics and/or text based that merely identifies the general content of the drive 108. In still further alternate embodiments, the contents of the graphic/text region 904 can be controlled by an independent source and/or can be blank. In still further alternate embodiments, the graphics/text region 904 can be merely a region adapted to selectively receive an adhesive sticker containing identifying information that may be selectively and/or permanently adhered to the package 902. In still further alternate embodiments, the region 904 may not be present.

In the embodiment depicted in FIG. 9, the device includes an internal message section 906. In the embodiment depicted in FIG. 9, the internal message section 906 can be, as in a standard brochure, written content located between a front and back, foldable cover. That is, the package itself can be folded in any known and/or convenient manner to have a front and back and any number of interior surfaces. However, in alternate embodiments the internal message section 906 can be permanently and/or removably coupled with the interior and/or exterior of the package 902 in any known and/or convenient manner and in any known and/or convenient location on the package 902. In still further alternate embodiments, the internal message section 906 may be absent.

In the embodiment depicted in FIG. 9, the digital content drive 108 can be coupled with the package in any known and/or convenient manner and have any desired features as described in with reference to FIGS. 1-1C. In some embodiments, the drive 108 can be coupled with the package in any one or more of the manner described above in relation to FIGS. 1-1C.

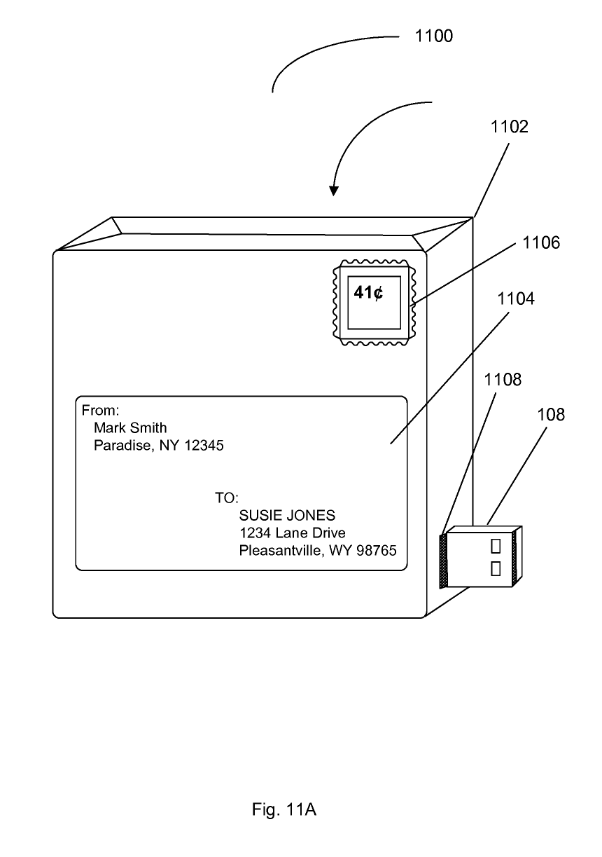

FIG. 10 depicts an embodiment of an advertisement delivery system 1000. In the embodiment depicted in FIG. 10, the delivery system 1000 can be comprised of a package 1002 that can include a graphic/text region 1004, an internal message section 1006 and a digital content drive 108.

In some embodiments the graphic/text region 1004 can be a display that can be associated with the digital content stored on the drive 108. Moreover, in some embodiment, the graphic/text region 1004 can access portions of the data stored on the drive 108 and display static and/or changing text and graphics depending on the contents of the drive 108. In alternate embodiments, the graphic/text region 1004 can be static graphics and/or text based that merely identifies the general content of the drive 108. In still further alternate embodiments, the contents of the graphic/text region 1004 can be controlled by an independent source and/or can be blank. In still further alternate embodiments, the graphics/text region 1004 can be merely a region adapted to selectively receive an adhesive sticker containing identifying information that may be selectively and/or permanently adhered to the package 1002. In still further alternate embodiments, the region 1004 may not be present.

In the embodiment depicted in FIG. 10, the device includes an internal message section 1006. In the embodiment depicted in FIG. 10, the internal message section 1006 can be, as in a standard brochure, written content located between a front and back, foldable cover. That is, the package itself can be folded in any known and/or convenient manner to have a front and back and any number of interior surfaces. However, in alternate embodiments the internal message section 1006 can be permanently and/or removably coupled with the interior and/or exterior of the package 1002 in any known and/or convenient manner and in any known and/or convenient location on the package 1002. In still further alternate embodiments, the internal message section 1006 may be absent.

In the embodiment depicted in FIG. 10, the digital content drive 108 can be coupled with the package in any known and/or convenient manner and have any desired features as described in with reference to FIGS. 1-1C. In some embodiments, the drive 108 can be coupled with the package in any one or more of the manner described above in relation to FIGS. 1-1C.

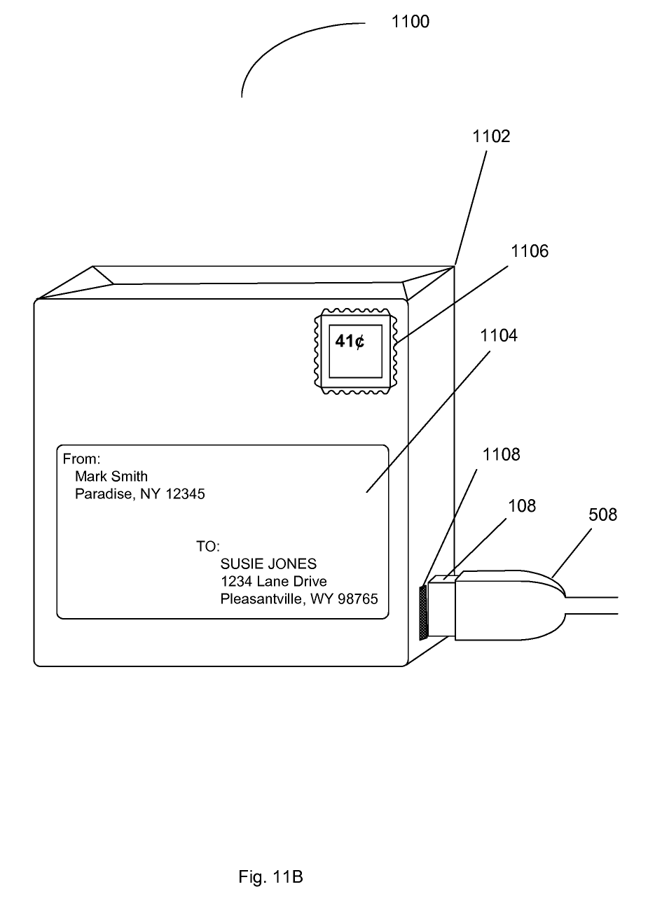

FIGS. 11A and 11B depict an embodiment of a mailing package 1100. In the embodiment depicted in FIGS. 11A and 11B, the delivery system 1100 can be comprised of a package 1002 that can include a graphic/text region 1004, a postage region 1006 and a digital content drive 108.

In the embodiment depicted in FIGS. 11A and 11B, the graphic/text region 1104 can be adapted to be a writable region, such that a user can write a delivery and/or a return address within the region. In some embodiments the graphic/text region 1104 can be a display that can be associated with the digital content stored on the drive 108. Moreover, in some embodiment, the graphic/text region 1104 can access portions of the data stored on the drive 108 and display delivery and/or return address information. In further alternate embodiments, the graphics/text region 1104 can be merely a region adapted to selectively receive an adhesive sticker containing identifying information that may be selectively and/or permanently adhered to the package 1102. In still further alternate embodiments, the region 1104 may not be present.

In the embodiments depicted in FIGS. 11A and 11B, the package 1102 can include a postage region 1106. The postage region can be adapted to be bondable with standard postage. In alternate embodiments, the region may not be present.

In the embodiment depicted in FIG. 10, the digital content drive 108 can be coupled with the package in any known and/or convenient manner and have any desired features as described in with reference to FIGS. 1-1C. In some embodiments, the drive 108 can be coupled with the package in any one or more of the manner described above in relation to FIGS. 1-1C.

In the embodiment depicted in FIGS. 11A and 11B, the package can include a slidable cover 1108. In a first position, the slidable cover can allow the engagement portion of the digital content drive 108 to pass through the exterior surface of the package 1102 and in a second position, it can cover the engagement portion of the digital content drive 108.

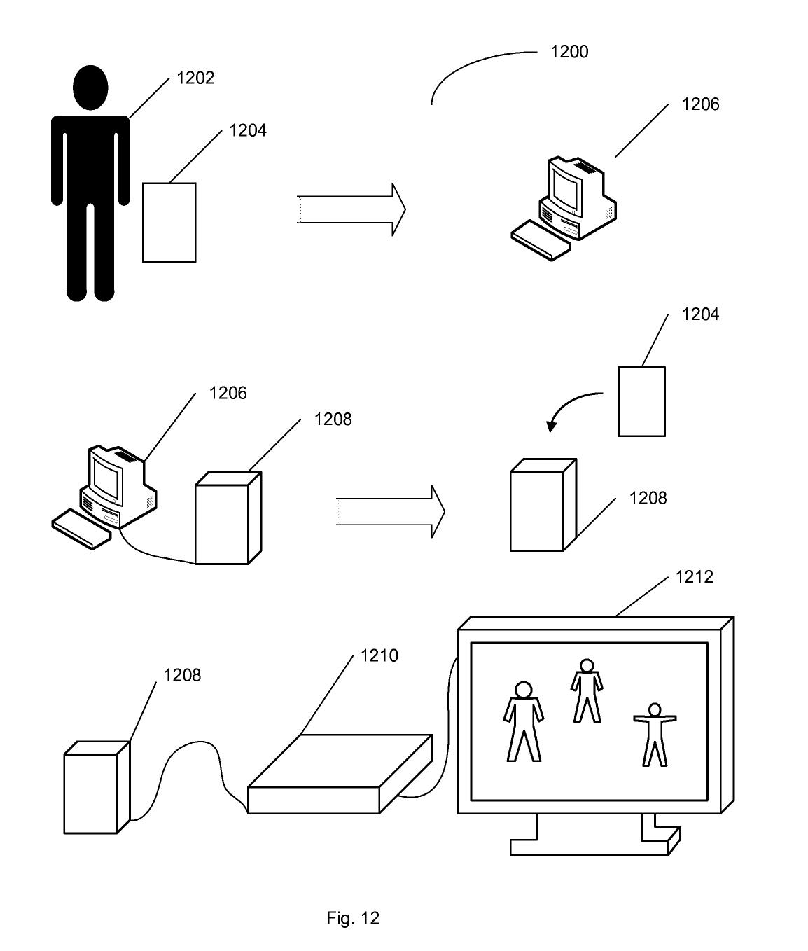

FIG. 12 depicts an in-store system that can utilize one or more of the packages 202-1102 described above. In some embodiments, a consumer 1202 can select an identifier 1204 for a digital product from a shelf and/or from a catalog and/or from any other physical location within a store and/or can retrieve and print and/or generate the identifier from any other source. The consumer 1202 can then take the identifier 1204 to any cashier and/or automated cash register device and pay for the desired content. After payment for the content has occurred and/or during the payment process and/or prior to the payment process, a package (as described in detail above) 1208 can be obtained and coupled either via physical tether or wirelessly and/or via any other known and/or convenient connection mechanism and the consumer-desired digital content can be activated and/or transferred to the digital content drive 108 on the package. Simultaneously with the transfer/activation, prior to the transfer/activation and/or after the transfer/activation, the transfer/activation can be logged. The log can be used to invoice, bill and or record transfers/activations of the digital content and such information can be used to charge the store for the product. The charge can be instantaneous and/or can occur at any time prior or subsequent to the activation/transfer.

The identifier 1204 and/or any other desired physical materials can then be placed in and/or on the package 1208. The consumer/user 1208 can then use the digital content on any desired device 1210 and, if necessary, receive sensory output of the content on an output device 1212. In some embodiments, the content can be audio/visual content and/or software capable of running on a computing system. However, in alternate embodiments the digital content can be any digital content.

It will be readily apparent to those of ordinary skill in the art, that the system described in FIG. 12 can be implemented in various forms and or using various additional steps and/or can be implemented using fewer steps.

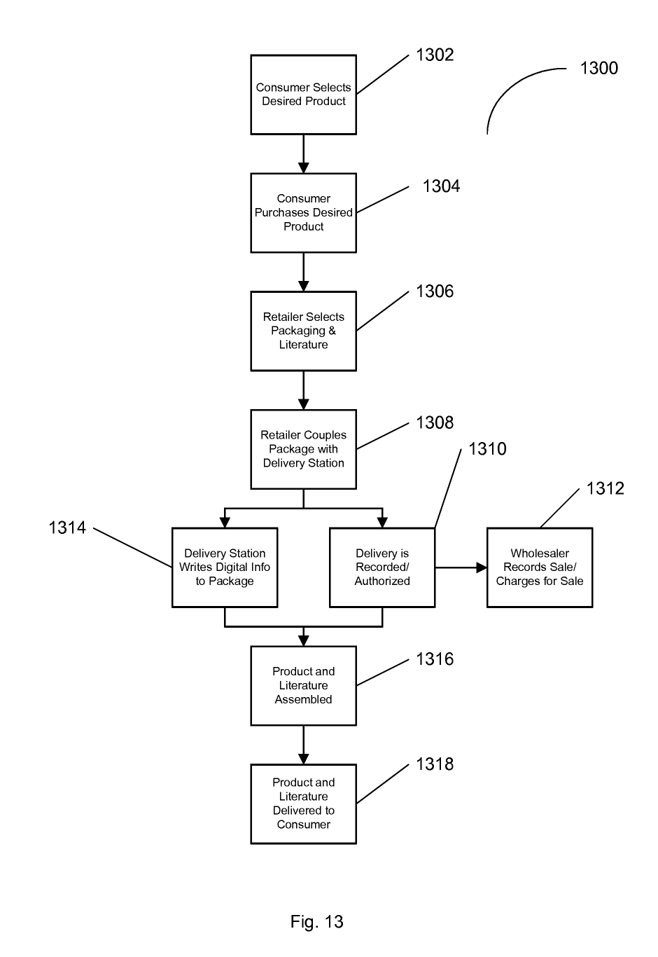

FIG. 13 depicts an embodiment of a method of digital content distribution comprising the steps of product selection 1302, purchase 1304, package selection 1306, coupling 1308, delivery/recordation 1310 1312, transfer/activation 1314, assembly 1316 and delivery to consumer 1318.

In step 1302, a user/consumer selects a desired digital content product 1302. In some embodiments, this can happen within a physical store and/or can happen in a virtual/online store via the internet.

Then in step 1304, a user/consumer purchases the desired digital content product 1304. In some embodiments, this can happen in a physical store with the consumer present and/or it can happen in a virtual/online store via the internet.

In step 1306, the retailer selects appropriate packaging for the desired digital content product and retrieves any desired additional contents and/or literature that may be packaged with the desired digital content product.

In step 1308, the retailer couples the packaging with a digital content delivery system. In some embodiments the couple can be a physical connection however, in alternate embodiments it can be a wireless couple and/or the couple can occur in any known and/or convenient manner which would allow the transfer of a signal between the system and the package.

In step 1310, transfer/activation of the product is authorized. In some embodiments, the authorization can occur via the internet at the time the content is transferred. However, in alternate embodiments authorization can be obtained prior to the transfer/activation.

In step 1312, the retailer records the authorization and can either accrue an invoice to the wholesale supplier and/or can immediately pay the wholesale supplier for the digital content product.

Simultaneously, prior and/or subsequently to the authorization and/or recordation, the system can write/activate the digital content product to the digital content drive 108 located within/on the package.

In steps 1316 and 1318, the components of the package are assembled and delivered to the consumer/user.

In some embodiments, the digital content drive can be configured such that the data stored on the digital content drive can only be access for a fixed period of time and/or a maximum number of times. Moreover, any desired security features can be implemented within the digital content to prohibit/restrict unauthorized use. By way of non-limiting example, the digital content could be encoded such that a maximum of 3 installations of a software package would be permitted. In an alternate, non-limiting example, in some embodiments the digital content of a movie could be configured to run for a maximum of 24 hours after the data is initially accessed.

To those of ordinary skill in the art, it will be readily apparent that any known and/or convenient digital rights management method/mechanism can be employed due to the read/write capabilities of the digital content drive 108.

In some embodiments, the system can be automated. In alternate embodiments, the package 1208 can be pre-customized based on specific content and/or can contain any desired documents and/or items.

While depicted as using USB connections in some figures, it will be readily evident to any person of ordinary skill in the art that the USB connection and/or device can be substituted with any known and/or convenient non-volatile memory/storage device.

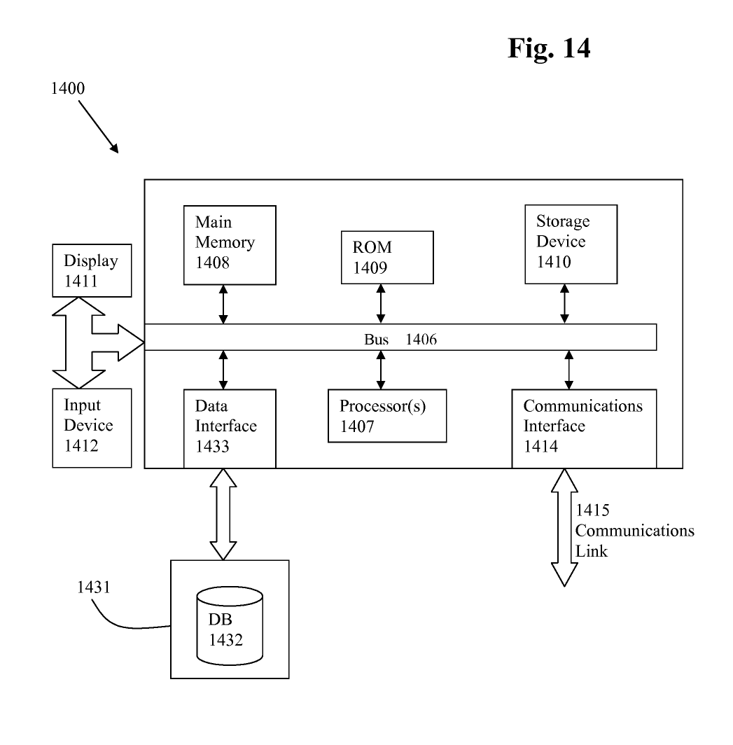

The execution of the sequences of instructions required to practice the embodiments may be performed by a computer system 1400 as shown in FIG. 14. In an embodiment, execution of the sequences of instructions is performed by a single computer system 1400. According to other embodiments, two or more computer systems 1400 coupled by a communication link 1415 may perform the sequence of instructions in coordination with one another. Although a description of only one computer system 1400 will be presented below, however, it should be understood that any number of computer systems 1400 may be employed to practice the embodiments.

A computer system 1400 which may be implemented according to some embodiments will now be described with reference to FIG. 14, which is a block diagram of the functional components of a computer system 1400. As used herein, the term computer system 1400 is broadly used to describe any computing device that can store and independently run one or more programs.

Each computer system 1400 may include a communication interface 1414 coupled to the bus 1406. The communication interface 1414 provides two-way communication between computer systems 1400. The communication interface 1414 of a respective computer system 1400 transmits and receives electrical, electromagnetic or optical signals, that include data streams representing various types of signal information, e.g., instructions, messages and data. A communication link 1415 links one computer system 1400 with another computer system 1400. For example, the communication link 1415 may be a LAN, in which case the communication interface 1414 may be a LAN card, or the communication link 1415 may be a PSTN, in which case the communication interface 1414 may be an integrated services digital network (ISDN) card or a modem, or the communication link 1415 may be the Internet, in which case the communication interface 1414 may be a dial-up, cable or wireless modem.

A computer system 1400 may transmit and receive messages, data, and instructions, including program, i.e., application, code, through its respective communication link 1415 and communication interface 1414. Received program code may be executed by the respective processor(s) 1407 as it is received, and/or stored in the storage device 1410, or other associated non-volatile media, for later execution.

In an embodiment, the computer system 1400 operates in conjunction with a data storage system 1431, e.g., a data storage system 1431 that contains a database 1432 that is readily accessible by the computer system 1400. The computer system 1400 communicates with the data storage system 1431 through a data interface 1433. A data interface 1433, which is coupled to the bus 1406, transmits and receives electrical, electromagnetic or optical signals, that include data streams representing various types of signal information, e.g., instructions, messages and data. In embodiments, the functions of the data interface 1433 may be performed by the communication interface 1414.

Computer system 1400 includes a bus 1406 or other communication mechanism for communicating instructions, messages and data, collectively, information, and one or more processors 1407 coupled with the bus 1406 for processing information. Computer system 1400 also includes a main memory 1408, such as a random access memory (RAM) or other dynamic storage device, coupled to the bus 1406 for storing dynamic data and instructions to be executed by the processor(s) 1407. The main memory 1408 also may be used for storing temporary data, i.e., variables, or other intermediate information during execution of instructions by the processor(s) 1407.

The computer system 1400 may further include a read only memory (ROM) 1409 or other static storage device coupled to the bus 1406 for storing static data and instructions for the processor(s) 1407. A storage device 1410, such as a magnetic disk or optical disk, may also be provided and coupled to the bus 1406 for storing data and instructions for the processor(s) 1407.

A computer system 1400 may be coupled via the bus 1406 to a display device 1411, such as, but not limited to, a cathode ray tube (CRT), for displaying information to a user. An input device 1412, e.g., alphanumeric and other keys, is coupled to the bus 1406 for communicating information and command selections to the processor(s) 1407.

According to one embodiment, an individual computer system 1400 performs specific operations by their respective processor(s) 1407 executing one or more sequences of one or more instructions contained in the main memory 1408. Such instructions may be read into the main memory 1408 from another computer-usable medium, such as the ROM 1409 or the storage device 1410. Execution of the sequences of instructions contained in the main memory 1408 causes the processor(s) 1407 to perform the processes described herein. In alternative embodiments, hard-wired circuitry may be used in place of or in combination with software instructions. Thus, embodiments are not limited to any specific combination of hardware circuitry and/or software.

The term “computer-usable medium,” as used herein, refers to any medium that provides information or is usable by the processor(s) 1407. Such a medium may take many forms, including, but not limited to, non-volatile, volatile and transmission media. Non-volatile media, i.e., media that can retain information in the absence of power, includes the ROM 1409, CD ROM, magnetic tape, and magnetic discs. Volatile media, i.e., media that cannot retain information in the absence of power, includes the main memory 1408. Transmission media includes coaxial cables, copper wire and fiber optics, including the wires that comprise the bus 1406. Transmission media can also take the form of carrier waves; i.e., electromagnetic waves that can be modulated, as in frequency, amplitude or phase, to transmit information signals. Additionally, transmission media can take the form of acoustic or light waves, such as those generated during radio wave and infrared data communications.

In the foregoing specification, the embodiments have been described with reference to specific elements thereof. It will, however, be evident that various modifications and changes may be made thereto without departing from the broader spirit and scope of the embodiments. For example, the reader is to understand that the specific ordering and combination of process actions shown in the process flow diagrams described herein is merely illustrative, and that using different or additional process actions, or a different combination or ordering of process actions can be used to enact the embodiments. The specification and drawings are, accordingly, to be regarded in an illustrative rather than restrictive sense.

It should also be noted that the present invention may be implemented in a variety of computer systems. The various techniques described herein may be implemented in hardware or software, or a combination of both. Preferably, the techniques are implemented in computer programs executing on programmable computers that each include a processor, a storage medium readable by the processor (including volatile and non-volatile memory and/or storage elements), at least one input device, and at least one output device. Program code is applied to data entered using the input device to perform the functions described above and to generate output information. The output information is applied to one or more output devices. Each program is preferably implemented in a high level procedural or object oriented programming language to communicate with a computer system. However, the programs can be implemented in assembly or machine language, if desired. In any case, the language may be a compiled or interpreted language. Each such computer program is preferably stored on a storage medium or device (e.g., ROM or magnetic disk) that is readable by a general or special purpose programmable computer for configuring and operating the computer when the storage medium or device is read by the computer to perform the procedures described above. The system may also be considered to be implemented as a computer-readable storage medium, configured with a computer program, where the storage medium so configured causes a computer to operate in a specific and predefined manner. Further, the storage elements of the exemplary computing applications may be relational or sequential (flat file) type computing databases that are capable of storing data in various combinations and configurations.

Although exemplary embodiments of the invention have been described in detail above, those skilled in the art will readily appreciate that many additional modifications are possible in the exemplary embodiments without materially departing from the novel teachings and advantages of the invention. Accordingly, these and all such modifications are intended to be included within the scope of this invention construed in breadth and scope in accordance with the appended claims.

What is claimed is:

1. A digital content drive mailing device, comprising:
a substantially planar member having a first surface and a second surface,
said first surface of said substantially planar member having a protrusion attached thereto,
said protrusion having an opening for receiving a digital content drive.
